(19) United States
(12) Patent Application Publication
(10) Pub. No.: US 2010/0310292 A1
(43) Pub. Date: Dec. 9, 2010

(54) METHOD AND APPARATUS FOR FORMING IMAGE

(75) Inventors: Kimiaki FURUKAWA, Shizuoka (JP); Susumu KOIZUMI, Shizuoka (JP); Atsushi YAMAZOE, Shizuoka (JP)

Correspondence Address: PATTERSON & SHERIDAN, L.L.P., 3040 POST OAK BOULEVARD, SUITE 1500, HOUSTON, TX, 77056, US

(73) Assignees: KABUSHIKI KAISHA TOSHIBA, Tokyo (JP); TOSHIBA TEC KABUSHIKI KAISHA, Tokyo (JP)

(21) Appl. No.: 12/792,621

(22) Filed: Jun. 2, 2010

Related U.S. Application Data
(60) Provisional application No. 61/183,665, filed on Jun. 3, 2009.
(60) Provisional application No. 61/183,679, filed on Jun. 3, 2009.
(60) Provisional application No. 61/183,681, filed on Jun. 3, 2009.
(60) Provisional application No. 61/184,701, filed on Jun. 5, 2009.
(60) Provisional application No. 61/184,705, filed on Jun. 5, 2009.
(60) Provisional application No. 61/184,716, filed on Jun. 5, 2009.
(60) Provisional application No. 61/184,719, filed on Jun. 5, 2009.
(60) Provisional application No. 61/184,721, filed on Jun. 5, 2009.
(60) Provisional application No. 61/187,179, filed on Jun. 15, 2009.
(60) Provisional application No. 61/244,755, filed on Sep. 22, 2009.

(51) Int. Cl. G03G 15/00

(52) U.S. Cl. 399/381

(57) ABSTRACT

According to one embodiment, a method for forming an image including, making an image on an image holing member, pressing a nip between the image holding member and a pressure applying member, and controlling the pressure applying to the nip with first pressure before a leading edge of a sheet enters to the nip and second pressure before a leading edge of a sheet thicker than the first sheet enters to the nip.

### CROSS-REFERENCE TO RELATED APPLICATIONS

This application is based upon and claims the benefit of priority from: U.S. Provisional Applications No. 61/183,665, No. 61/183,679 and No. 61/183,681, each filed on Jun. 3, 2009, U.S. Provisional Applications No. 61/184,701, No. 61/184,705, No. 61/184,716, No. 61/184,719 and No. 61/184,721, each filed on Jun. 5, 2009, U.S. Provisional Application No. 61/187,179 filed on Jun. 15, 2009, and U.S. Provisional Application No. 61/244,755, filed on Sep. 22, 2009, the entire contents of each of which are incorporated herein reference.

### FIELD

Embodiments described herein relates generally to an image forming apparatus and a sheet feeding mechanism.

### BACKGROUND

In an image forming apparatus, movement of a sheet that holds an image affects the quality of the image formed by elements that form the image. One of influences on the image quality includes “nonuniformity of image forming speed” caused when the sheet moves while the elements forming the image form the image.

### BRIEF DESCRIPTION OF THE DRAWINGS

A general architecture that implements the various features of the embodiments will now be described with reference to the drawings. The drawings and the associated descriptions are provided to illustrate embodiments and not to limit the scope of the embodiments.

FIG. 1 is an exemplary diagram illustrating an apparatus;

FIG. 2 is an exemplary diagram illustrating a configuration of an imaging section incorporated in the apparatus shown in FIG. 1;

FIG. 3 is an exemplary diagram illustrating a transfer roller at a position for moving a toner image from a transfer belt to a sheet;

FIG. 4 is an exemplary diagram illustrating transfer roller separated from the transfer belt;

FIG. 5 is an exemplary diagram illustrating a mechanism configured to move a pusher;

FIG. 6 is an exemplary block diagram illustrating a control system of the apparatus;

FIG. 7 is an exemplary diagram illustrating a cam a pusher in a non-pressed state;

FIG. 8 is an exemplary diagram illustrating a cam profile according to FIG. 7;

FIG. 9 is an exemplary diagram illustrating the cam and the pusher in a pressed state;

FIG. 10 is an exemplary diagram illustrating a state in which an outer circumference A section of the cam moves the pusher;

FIG. 11 is an exemplary diagram illustrating a state in which the outer circumference C section of the cam moves the pusher;

FIG. 12 is a first exemplary timing chart illustrating a transfer pressure reduction;

FIG. 13 is an exemplary diagram illustrating a shape of a cam without a recess on the outer circumference thereof;

FIG. 14 is a second exemplary timing chart illustrating a transfer pressure reduction;

FIG. 15 is a third exemplary timing chart illustrating a transfer pressure reduction;

FIG. 16 is an exemplary diagram illustrating a cam profile according to FIG. 15;

FIG. 17 is a fourth exemplary timing chart illustrating a transfer pressure reduction; and

FIG. 18 is an exemplary diagram illustrating a cam profile according to FIG. 17.

### DETAILED DESCRIPTION

Various embodiments will be described hereinafter with reference to the accompanying drawings. In general, according to one embodiment, a method for forming an image including, making an image on an image holing member, pressing a nip between the image holding member and a pressure applying member, and controlling the pressure applying to the nip with first pressure before a leading edge of a sheet enters to the nip and second pressure before a leading edge of a sheet thicker than the first sheet enters to the nip.

Embodiments will now be described hereinafter in detail with reference to the accompanying drawings.

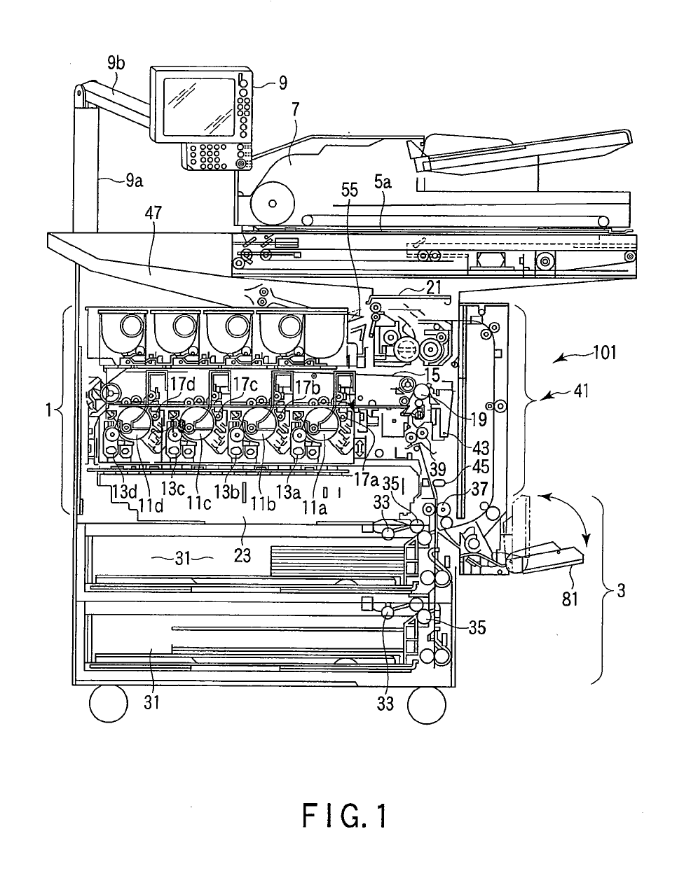

FIG. 1 schematically shows an MFP (Multi-Functional Peripheral) to which the embodiment is able to apply.

An MFP 101 shown in FIG. 1 has a printer 1 for outputting image information as an output image which is referred to as a hard copy or a print out a sheet feeder 3 to supply to the printer 1 a sheet having an optional size which is used for an image output, and an scanner 5 for providing image data of an original to the printer 1.

Moreover, the scanner 5 integrally has an automatically-document feeder (ADF) 7 the original to a reading position on the scanner 5. A control panel 9 for giving an instruction for starting image formation in the printer 1 and starting to read image information of the original through the scanner 5 is placed in a strut 9a fixed to the printer 1 and a swing arm 9b in a corner at a left or right side behind the scanner 5.

The printer 1 includes first to fourth photoconductive drums 11a to 11d for holding latent images, developers 13a to 13d for supplying a toner to the latent images on the photoconductive drums 11a to 11d to develop toner images, a transfer belt 15 for holding the toner images transferred from the photoconductive drums 11a to 11d in order, cleaners 17a to 17d for cleaning the individual photoconductive drums 11a to 11d, a transfer roller 19 for transferring the toner image held by the transfer belt 15 onto a sheet, a fuser 21 for fixing the toner image transferred to the sheet by the transfer roller 19 onto the sheet, and an exposing device 23 for forming latent images on the photoconductive drums 11a to 11d.

The first to fourth developers 13a to 13d store toners having optional colors of Y (yellow), M (magenta), C (cyan) and Bk (black) which are used for obtaining a color image by a subtractive process and visualize a latent image held by each of the photoconductive drums 11a to 11d in any of the colors Y, M, C and Bk. The respective colors are determined in predetermined order corresponding to an image forming process or a characteristic of the toner.

The transfer belt 15 holds the toner images having the respective colors which are formed by the first to fourth photoconductive drums 11a to 11d to 11d and the corresponding developers 13a to 13d in order (of the formation of the toner images).

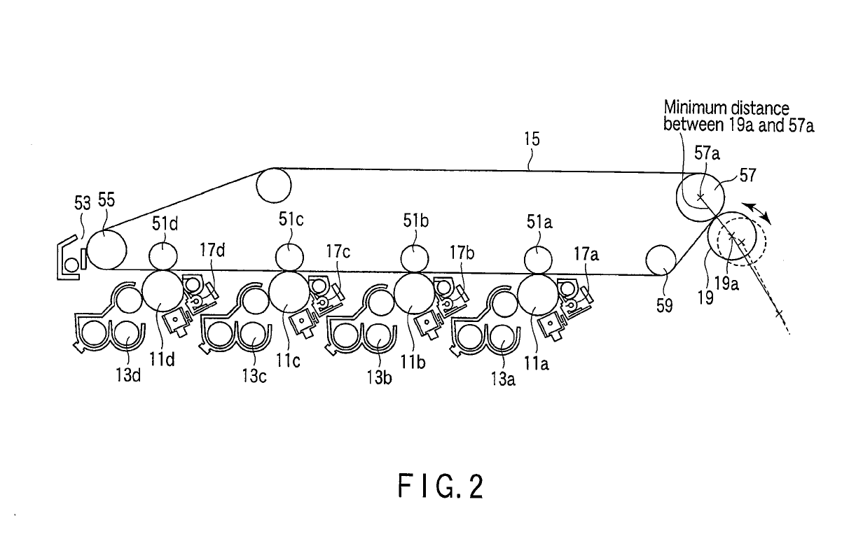

As explained later with reference to FIG. 2, the transfer belt 15 receives predetermined pressure from each of a pre-transfer rollers 51 configured to set pressure between photoconductive drums 11a to 11d of the image forming section 1 and the transfer belt 15, a first roller 55 configured to set pressure applied by a belt cleaner 53 configured to clean the surface of the transfer belt 15, and a supporting roller 57 configured to set pressure applied when the sheet comes into contact with the transfer belt 15 with the pressure from the transfer roller 19.

The sheet feeder 3 supplies the sheet to be transferred the toner image by the transfer roller 19.

Cassettes positioned in a plurality of cassette slots 31 store sheets having optional sizes. Depending on an image forming operation, a pickup roller 33 takes the sheet out of the corresponding cassette. The size of the sheet corresponds to a size of the toner image formed by the printer 1.

A separating mechanism 35 prevents at least two sheets from being taken out of the cassette by the pickup roller 33.

A plurality of delivery rollers 37 feed the sheet separated to be one sheet by the separating mechanism 35 toward an aligning roller 39.

The aligning roller 39 feeds the sheet to a transfer position in which the transfer roller 19 and the transfer belt 15 come in contact with each other in a timing for transferring the toner image from the transfer belt 15 by the transfer roller 19.

The fuser 21 fixes the toner image corresponding to the image information onto the sheet as the output image (hard copy, print out) and feeds the output image to a stocker 47 positioned in a space between the scanner 5 and the printer 1.

The transfer roller 19 is positioned in an automatically-duplex unit (ADU) 41 for replacing both sides of the sheet, that is, the output image (hard copy, print out) which has the toner image fixed thereto by the fuser 21. A bypass tray 81 is attached to the ADU 41.

The ADU 41 moves to a side (a right side) with respect to the printer 1 when the sheet is jammed between the delivery roller 37 (a final one) and the aligning roller 39 or between the aligning roller 39 and the fuser 21, that is, in the transfer roller 19 or the fuser 21. The ADU 41 integrally has a cleaner 43 for cleaning the transfer roller 19.

A media sensor 45 to detect thickness of the sheet conveyed to the aligning roller 39 in the path between the delivery roller 37 and the aligning roller 39. The media sensor 45 useable an optical type benefit of priority from: U.S. patent application Ser. No. 12/197,880 filed on Aug. 25, 2008 and U.S. patent applications Ser. No. 12/199,424 filed on Aug. 27, 2008 and/or a shift of thickness detecting roller type benefit of priority from: U.S. Provisional Application No. 61/043,801 filed on Apr. 10, 2008, each of which are incorporated.

FIG. 2 shows the transfer section of the printer in the MFP, shown in FIG. 1.

The deflection of the belt surface of the transfer belt 15 is a fixed amount related to the tension from at least one tension device. The pre-transfer rollers 51, the first roller 55, and the supporting roller 57 are, for example, roller bodies. The pre-transfer rollers 51 respectively transfer toner images from the photoconductive drums 11a to 11d. The transfer roller 19 applies pressure to the sheet (and the transfer belt 15) when the sheet moves between the transfer roller 19 and the transfer belt 15. The transfer roller 19 provides the sheet (and the transfer belt 15) with the transfer voltage (the electrostatic field) from the not-shown power supply.

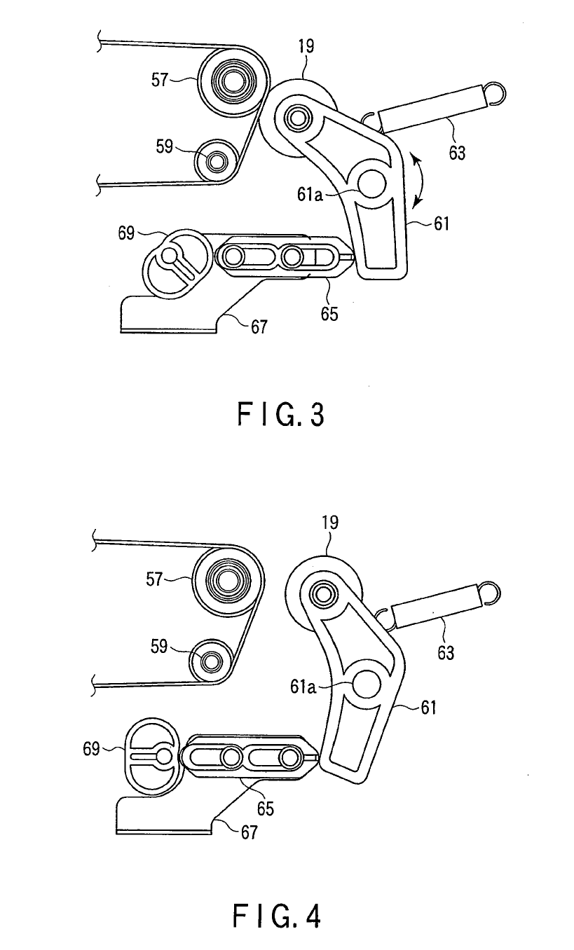

FIGS. 3 and 4 show the operation (the position) of the transfer roller for moving a toner image held by the transfer belt to the sheet.

The transfer roller 19 is supported by a supporting member 61 having a fulcrum 61a. A spring 63 applies, during non-transfer (during non-image formation), a load to the supporting member 61 such that, as shown in FIG. 4, the transfer roller 19 (supported by the supporting member 61) is located on a side not in contact with the supporting roller 57 and the transfer belt 15 located on the outer circumference of the supporting roller 57 (a separated state or a non-pressed state). During image formation (during a printing sequence), the supporting member 61 turns with the fulcrum 61a as a rotation center such that, as shown in FIG. 2, the transfer roller 19 is located in a position where the transfer roller 19 is in contact with, with predetermined pressure (for identification, referred to as transfer pressure or pressure for the sheet), the transfer belt 15 and the supporting roller 57 located on the inner side of the transfer belt 15. Image formation is allowed in a state in which the transfer roller 19 supported by the supporting member 61 moves to a position where a segment connecting a center axis 57a of the supporting roller 57 and a center axis 19a of the transfer roller 19 is a straight line (a distance between the two center axes is minimized) or a state in which the transfer roller 19 moves to a position where the transfer roller 19 turns to further to the side of an auxiliary member 59 configured to apply tension to the transfer belt 15 in cooperation with the supporting roller 57 than the position (where the distance between the two center axes is minimized).

A pusher 65 linearly moves to apply pressure (for identification, referred to as propulsion pressure or pressure for turning the supporting member) to the supporting member 61.

The propulsion pressure (i.e., a movement amount of the pusher 65) allows the transfer roller 19 supported by the supporting member 61 to come into contact with the transfer belt 15 (a contact state). A guide (a pusher supporting body) 67 guides the pusher 65 to linearly (reciprocatingly) move. The guide 67 is formed in a pin shape when, for example, the pusher 65 has a long hole (a parallel groove) extending in one direction. The guide 67 only has to be formed in a parallel groove or rail shape when, for example, the pusher 65 is a projection (or a pin or rib shape).

A cam 69 sets a movement amount of the pusher 65 (according to the rotation of the cam 69 itself).

Transfer pressure acting on the sheet moving between the transfer roller 19 and the transfer belt 15 changes according to the movement amount of the pusher 65. In other words, the transfer pressure acting on the sheet between the transfer roller 19 and the transfer belt 15 can be arbitrarily set by changing the movement amount of the pusher 65. In other words, the transfer pressure acting on the sheet between the transfer roller 19 and the transfer belt 15 can be arbitrarily set by changing the movement amount of the pusher 65.

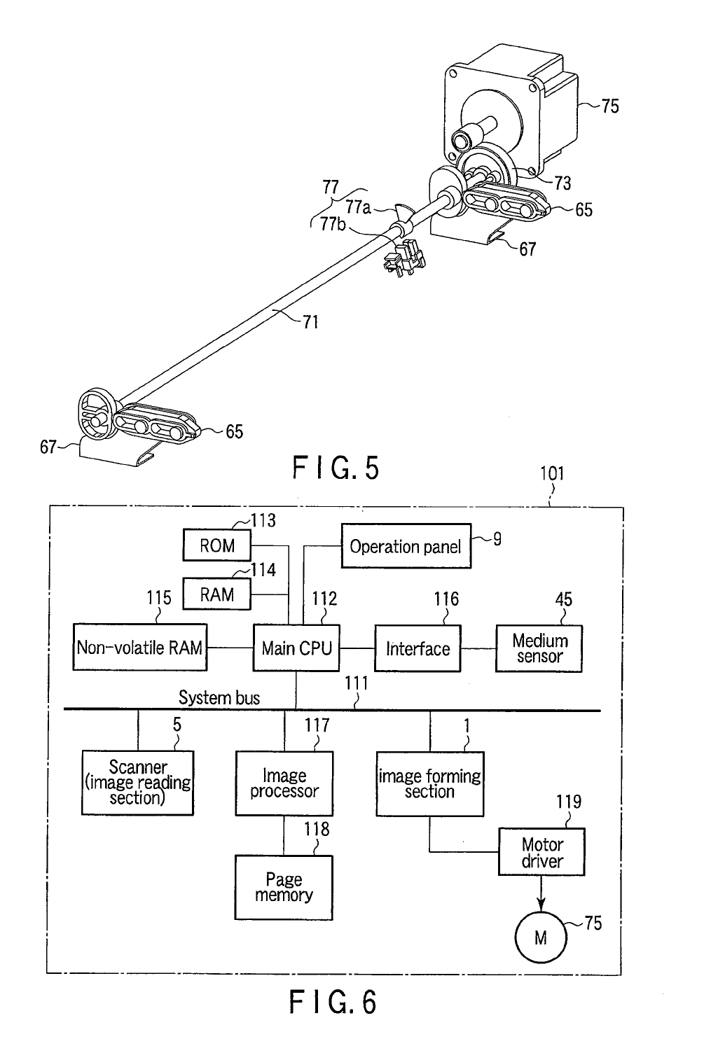

FIG. 5 shows an example of a mechanism configured to move reciprocatingly the pusher shown in FIGS. 3 and 4.

According to the reciprocating movement of the pusher 65 by the rotation of the cam 69, the transfer roller 19 supported by the supporting member 61 is located in a position of a state in which the transfer roller 19 applies transfer pressure to the transfer belt 15 and the supporting roller 57 (the contact state) or the non-pressed state (the separated state). The cam 69 is supported by a shaft 71. The shaft 71 receives the rotation of a stepping motor 75 with a gear 73. The stepping motor 75 rotates in a first direction and a second direction opposite to the first direction. A rotation amount (a rotation angle) of the cam 69 is measured by a rotation sensor 77 including an actuator 77a held by the shaft 71 and a position detection sensor 77b configured to detect presence or absence of the actuator 77a. Specifically, when the actuator 77a passes the position sensor 77b, the magnitude or the polarity of a sensor signal output by the sensor 77b is switched. The rotation angle (a rotation position) of the cam 69 stops in a specified position with the switching as a trigger.

A movement amount given to the supporting member 61 by the pusher 65 is determined according to the positions of the sensor blade 77a to accurately set the transfer pressure applied to the transfer belt 15 and the supporting roller 57 by the transfer roller 19.

FIG. 6 shows a control system of the MFP illustrated in FIGS. 1 to 5.

The MFP (image forming apparatus) 101 includes a system bus line 111. The system bus line 111 connects a main control block, that is, a main CPU 112 for processing image information of an object to be outputted by a printer 1 including the scanner (scanner) 5 and an image processor 117, and the printer 1. The printer 1 includes a motor driver 119 which provides electric pulse to rotate the stepping motor 75. A rotational angle of the stepping motor 75 is proportional to a number of the pulses. A rotation speed is in proportional to a rate of the pulses. The main control block 112 connects an ROM (Read Only Memory) 113, an RAM (Random Access Memory) 114, and a non-volatile RAM 115 for storing a total number of times of image formation, a total operating (working) time or the like, an interface 116 for inputting an output of the media sensor 45 to the main control block 112, and the operation panel 9. The image processor 117 connects a page memory 118.

### FIRST EMBODIMENT

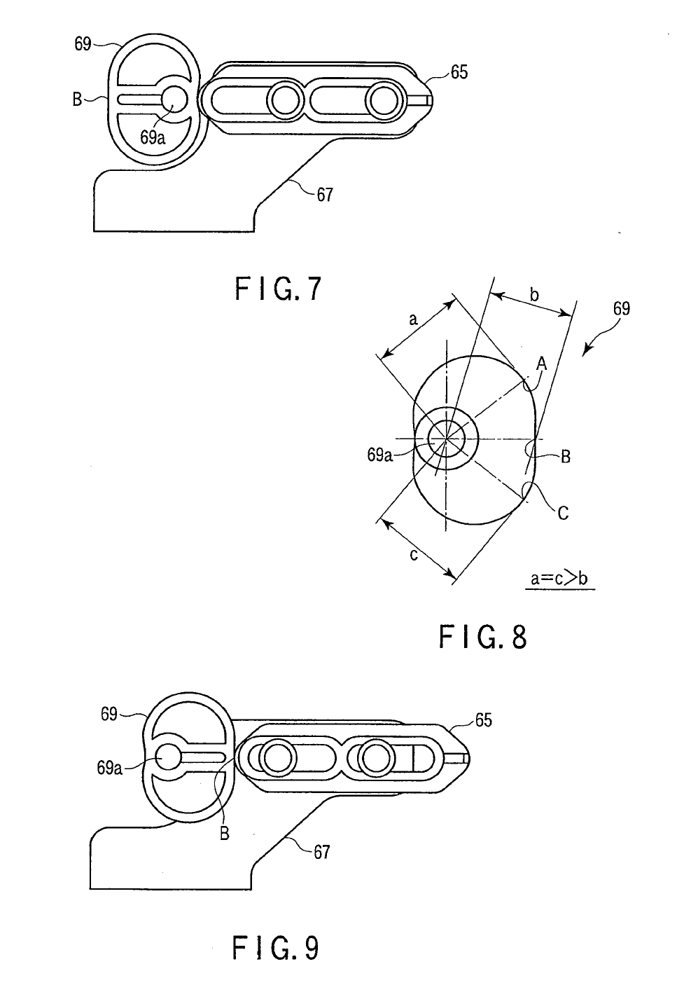

FIG. 7 shows the operation of the transfer roller schematically shown in FIGS. 3 and 4 and a rotation amount (a rotation angle) of the cam and the position of the pusher in the non-pressed state (the separated state) in which the transfer roller does not apply the transfer pressure to the transfer belt and the supporting roller. FIG. 8 shows a state of the cam viewed from a direction orthogonal to the axis of the shaft hole, i.e., a characteristic of a cam outer circumferential state.

The outer circumference of the cam 69 is formed in an oblong shape or an elliptical shape having at least one recess. An area of the pusher 65 set in contact with the outer circumference of the cam 69 is a convex curved surface.

In the cam 69, a distance “a” from the shaft hole 69a to an outer circumference A section and a distance “c” from the shaft hole 69a to an outer circumference C section are equal. A distance “b” from the shaft hole 69a to an outer circumference B section (a recess) is shorter than the distance “a” or the distance “c”. The distance between the outer circumference A section or the outer circumference C section and the shaft hole 69a is the largest. Specifically, an area between the outer circumference A section and the outer circumference B section and an area between the outer circumference B section and the outer circumference C section are shorter than the distance “a” or the distance “c” and longer than the distance “b”.

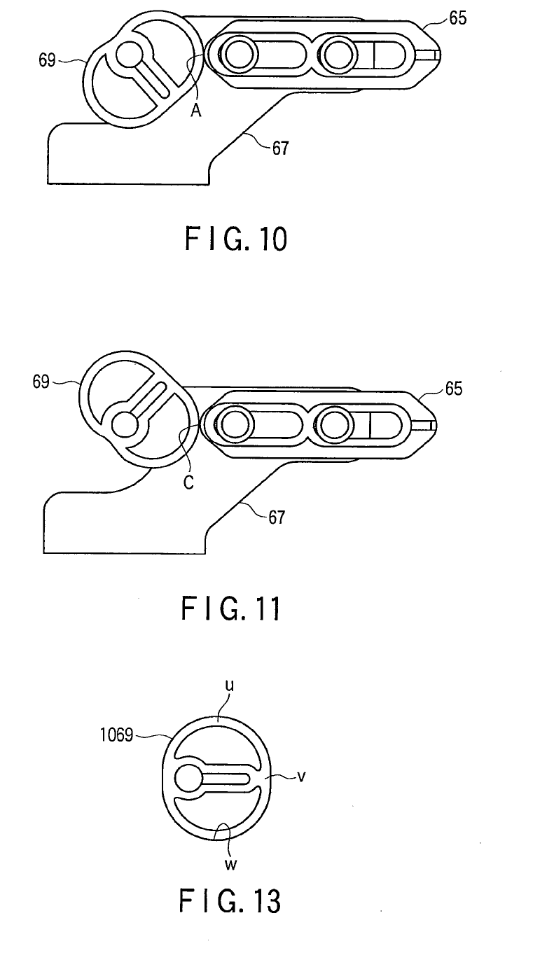

An example of the transfer pressure applied to the transfer belt 15 and the supporting roller 57 by the transfer roller 19 (a first embodiment) is explained below.

[1a] In the non-pressed state (the separated state), in the cam 69, as shown in FIG. 7, the recess (the B section shown in FIG. 8) is located on the opposite side of the pusher 65 with respect to the shaft hole 69a. Specifically, the transfer roller 19 does not apply pressure to the transfer belt 15 and the supporting roller 57.

[1b] When image formation is instructed, until the leading end of a first sheet moves to a transfer area where the transfer roller 19 and the transfer belt 15 are set in contact with each other (during toner image non-transfer), the cam 69 rotates according to the rotation of the stepping motor 75 such that the recess (the B section) is located on the pusher 65 side with respect to the shaft hole 69a as shown in FIG. 9. Therefore, pressure for setting the transfer roller 19 and the transfer belt 15 in contact with each other in the transfer area during toner image non-transfer is low compared with pressure during image transfer when the outer circumference A section or the outer circumference C section is set in contact with the pusher 65.

[1c] During toner image transfer, within a predetermined time in which the leading end of the sheet enters the transfer area, the cam 69 rotates in some direction according to the rotation of the stepping motor 75 such that the outer circumference A section or the outer circumference C section further moves the pusher 65. At this point, a relation between the cam and the pusher is a positional relation shown in FIG. 10 or 11. Consequently, transfer pressure higher than the pressure in [1b] necessary for transferring the toner image onto the sheet is applied to the toner image and the sheet.

[1d] Immediately before the trailing end of the sheet exits the transfer area, the cam 69 rotates in the opposite direction of the direction in [1c] according to the rotation of the stepping motor 75. Consequently, in a range of predetermined length at the trailing end of the sheet, pressure is low compared with pressure in the transfer area during toner image transfer same as the pressure in [1b]. The magnitude of the pressure in [1b] is magnitude not affecting an image.

[1e] When the next sheet moves, within a predetermined time in which the leading end of the sheet enters the transfer area, the cam 69 rotates in a direction same as the direction in [1d] and the outer circumference C section or the outer circumference B section of the cam 69 further moves the pusher 65 as in [1c]. Consequently, transfer pressure higher than the pressure in [1b] necessary for transferring the toner image onto the sheet is applied to the toner image and the sheet.

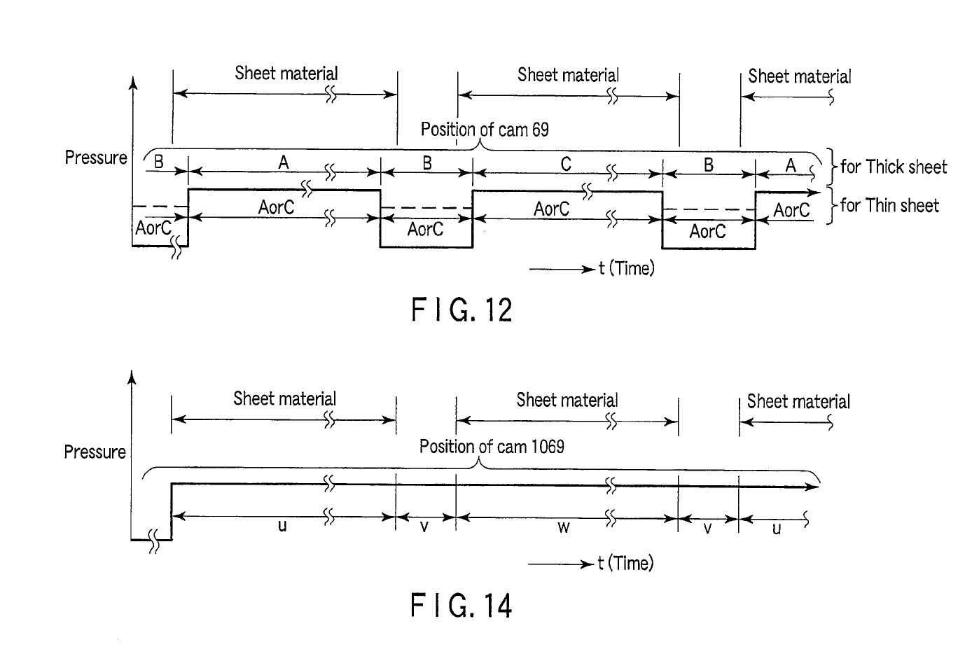

Repetition of [1b] to [1e] is an example of a control for reducing, as shown in FIG. 12, immediately before the leading end of the sheet enters the transfer area and for a predetermined time after the trailing end of the sheet exits the transfer area, the transfer pressure applied to the transfer belt 15 and the supporting roller 57 by the transfer roller 19.

### COMPARATIVE EXAMPLE

For comparison, an example in which [1b] to [1e] are executed by using a cam without a recess on the outer circumference thereof, a schematic shape of which is shown in FIG. 13, is explained. Specifically, in a cam 1069 shown in FIG. 13, compared with the cam 69 explained with reference to FIG. 8, all distances u, v, and w of an outer circumference U section, an outer circumference V section, and an outer circumference W section from a shaft hole are equal, i.e., u=v=w. When the cam 1069 shown in FIG. 13 is used, in the repetition of [1b] to [1e], as clearly indicated in FIG. 14 in which a method same as the method shown in FIG. 12 is used, the transfer pressure applied to the transfer belt and the supporting roller by the transfer roller is substantially fixed irrespectively of the entrance of the leading end of the sheet or the passage of the trailing end of the sheet. Therefore, a load applied to the sheet when the toner image is transferred onto the sheet is always fixed irrespectively of the thickness of the sheet. This causes instantaneous fluctuation in speed of the transfer belt because of the influence of high rigidity of the sheet during the transfer of the toner image onto a thick sheet (e.g., weight per 1 m² is 125 g/sheet).

The fluctuation in the speed of the transfer belt causes adverse effects on image quality such as a shift of the toner image. When the toner image is transferred onto the thick sheet, the transfer pressure applied to the transfer belt and the supporting roller by the transfer roller should be prevented from being always reduced because transfer efficiency indicating a degree of transfer of the toner image on the sheet falls.

### Second Embodiment

The pressure change shown in FIG. 12, i.e., the repetition of [1b] to [1e] allows the transfer pressure applied to the transfer belt 15 and the supporting roller 57 by the transfer roller 19 to slight fall substantially at the trailing end of a sheet (the preceding or first sheet) and the leading end of a sheet (the following or second sheet).

As explained above, from the viewpoint of the transfer efficiency indicating a degree of transfer of the toner image onto the sheet, it is desirable that the pressure in [1c] is applied to the entire area of the sheet while the sheet passes the transfer area.

Therefore,

[2b] while the leading end of the first sheet moves to the transfer area, a state in which the rotation of the cam 69 is temporarily stopped in the outer circumference A section or the outer circumference C section and the pusher 65 is moved by the largest distance is continued,

[2c] immediately before the leading end of the sheet enters the transfer area, the cam 69 is rotated such that the outer circumference B section moves the pusher 65,

[2d] from an instance when the leading end of the first sheet enters the transfer area, a state in which the rotation of the cam 69 is located in the outer circumference A section or the outer circumference C section again and the pusher 65 is moved by the largest distance is continued,

[2e] immediately before the trailing end of the sheet exits the transfer area, the cam 69 is rotated such that the outer circumference B section moves the pusher 65,

[2f] immediately after the trailing end of the sheet exits the transfer area, the cam 69 is rotated such that the outer circumference B section moves the pusher 65, and

[2g] while the leading end of the next sheet moves to the transfer area, a state in which the rotation of the cam 69 is temporarily stopped in the outer circumference A section or the outer circumference C section and the pusher 65 is moved by the largest distance is continued, whereby transfer pressure higher than the pressure in [2g] or the pressure in [1b] in FIG. 12 necessary for transferring the toner image onto the sheet is applied to the toner image and the sheet.

Specifically, repetition of [2b] to [2g] can once reduce, in the transfer area, the transfer pressure applied to the transfer belt 15 and the supporting roller 57 by the transfer roller 19 to a degree not affecting an image and reset, while the sheet moves in the section in which the toner image is transferred onto the sheet, the transfer pressure applied to the transfer belt 15 and the supporting roller 57 by the transfer roller 19 to the normal pressure.

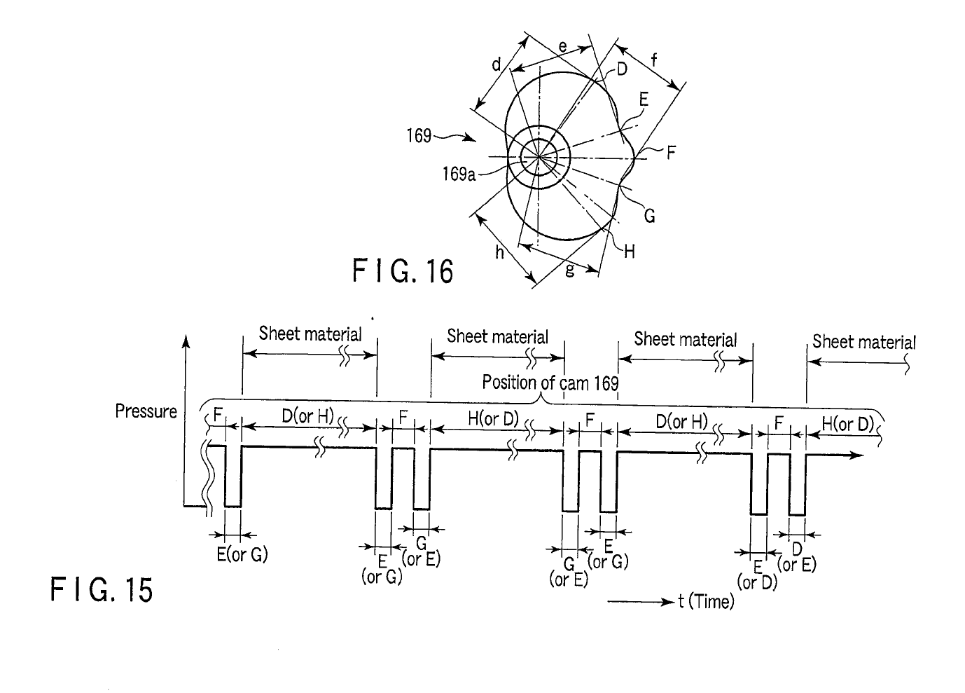

This makes it possible to further reduce, compared with the first embodiment, the size of a section where the transfer belt 15 is impacted when the sheet enters the transfer area or the sheet exits the transfer area (a ratio of the size to the length of the sheet). The repetition of [2b] to [2g] is an example in which the transfer pressure applied to the transfer belt 15 and the supporting roller 57 by the transfer roller 19 is controlled according to the passage of the leading end and the trailing end of the sheet as shown in FIG. 15.

### Third Embodiment

The first or second embodiment requests reversing (inverting) time for the cam that requires an interval between sheets moving in the transfer area. In some case, a load applied to the transfer belt long-periodically fluctuates depending on presence or absence of a sheet that moves in the transfer area. The long-periodical load fluctuation is a factor that causes a color shift.

An embodiment of a cam in which the color shift due to the long-periodical load fluctuation is prevented and the reversing (inverting) time of the cam can be reduced is explained as an example in which a state in which the cam is viewed from a direction orthogonal to the axis of the shaft hole of the cam, i.e., a cam outer circumferential shape has at least two recesses shown in FIG. 16.

In the outer circumference of a cam 169 (for identification, “100” is added), a distance “d” from a shaft hole 169a to an outer circumference D section, a distance “f” to an outer circumference F section (a projection located in the center), and a distance “h” to an outer circumference H section are equal. All the distances “d”, “g”, and “h” are equal. A distance “e” from the shaft hole 169a to an outer circumference E section (a first recess) and a distance “g” from the shaft hole 169a to an outer circumference G section (a second recess) are equal and are shorter than the distances “d”, “g”, and “h”. The outer circumference E section is located between the outer circumference D section and the outer circumference F section. The outer circumference G section is located between the outer circumference F section and the outer circumference H section. The projection located in the center (the F section) specifies the position of the pusher 65 between sheets (sets propulsion pressure applied to the supporting member 61 by the pusher 65 to pressure substantially equal to transfer pressure acting on the sheet moving between the transfer roller 19 and the transfer belt 15 during toner image transfer).

[3a] During standby, the cam 169 set in contact with the pusher 65 is set in contact with the pusher 65 in a 180°-reversed position and the transfer roller 19 and the supporting roller 57 are in a separated state.

[3b] When image formation is instructed, until the leading end of a first sheet enters the transfer area, the cam 169 applies propulsion pressure to the pusher 65 with the projection in the center (the outer circumference F section). The cam 169 applies, to the pusher 65, propulsion pressure substantially equal to the transfer pressure acting on the sheet moving between the transfer roller 19 and the transfer belt 15 during toner image transfer.

[3c] The rotation of the cam 169 starts immediately before the leading end of the sheet enters the transfer area.

[3d] At a point when the leading end of the sheet reaches the transfer area, the E section or the G section of the cam 169 moves the pusher 65. Therefore, at an instance when the leading end of the sheet reaches the transfer area, as in [2b] in FIG. 15, pressure is low compared with the pressure in the transfer area during toner image transfer.

[3e] At a point when the leading end of the sheet (completely) reaches the transfer area, the D section or the H section of the cam 169 moves the pusher 65. Therefore, at a point when the leading end of the sheet enters the transfer area, the pressure in the transfer area is recovered to necessary and sufficient pressure for transferring the toner image onto the sheet.

[3f] Immediately before the trailing end of the sheet exits the transfer area, the rotation of the cam 169 starts.

[3g] At an instance when the trailing end of the sheet exits the transfer area, the E section or the G section of the cam 169 moves the pusher 65. Therefore, at an instance when the trailing end of the sheet exits the transfer area, pressure in the transfer area is low compared with the pressure in the transfer area during toner image transfer as in [3d] (or [2b] in FIG. 15).

[3h] Thereafter, until the leading end of the next sheet enters the transfer area, the cam 169 temporarily stops in the outer circumference F section (the center projection) (or continuously rotates at predetermined speed corresponding to the interval between the sheets) and applies propulsion pressure to the pusher 65. [3c] to [3g] continue.

This makes it possible to further reduce, compared with the first embodiment, the size of the section where the transfer belt is impacted when the sheet enters the transfer area or the sheet exits the transfer area (a ratio of the size to the length of the sheet). Pressure changing operation is realized by reciprocating movement (normal rotation and reverse rotation) of the cam 169 at substantially fixed speed. Therefore, speed of image formation (transfer of the toner image) is increased. Repetition of [3c] to [3g] is substantially the same as that explained in the second embodiment with reference to FIG. 15.

### Fourth Embodiment

Even if the first or second embodiment is adopted, in some case, a load applied to the transfer belt long-periodically fluctuates depending on presence or absence of a sheet moving the transfer area. The long-periodical load fluctuation is a factor that causes a color shift.

An example in which, in order to prevent the color shift due to the long-periodical load fluctuation, a state in which the cam is viewed from a direction orthogonal to the axis of the shaft hole, i.e., a cam outer circumferential shape is a shape that can control a load applied to the transfer belt shown in FIG. 18 is explained.

FIG. 18 shows the state in which the cam is viewed from the direction orthogonal to the axis of the shaft hole, i.e., a characteristic of the cam outer circumferential shape. The outer circumference of a cam 269 (for identification, “200” is added) is formed in an oblong shape or an elliptical shape having at least one recess. An area of the pusher 65 set in contact with the outer circumference of the cam 269 is a convex curved surface.

In the cam 269, a distance “i” from a shaft hole 269a to an outer circumference I section is longer than both a distance “j” from the shaft hole 269a to an outer circumference J section and a distance “k” from the shaft hole 269a to an outer circumference K section. The distance “k” from the shaft hole 269a to the outer circumference K section is shorter than the distance “i” from the shaft hole 269a to the outer circumference I section but is longer than the distance “j” from the shaft hole 269a to the outer circumference J section. In short, the distance “i” > the distance “k”> the distance “j”. The distance “k” is longer than all of the distances “a” and “c” of the cam 69 shown in FIG. 8 and the distances “d”, “f”, and “g” of the cam 169 shown in FIG. 16. This indicates that the cam 269 further increases, in the outer circumference K section, the transfer pressure applied to the transfer belt 15 and the supporting roller 57 by the transfer roller 19 to be higher than pressure necessary in transferring a toner image onto a sheet.

An example of the transfer pressure applied to the transfer belt 15 and the supporting roller 57 by the transfer roller 19 in the transfer area (a fourth embodiment) is explained below.

[4a] In the non-pressed state (the separated state), in the cam 269, as substantially shown in FIG. 7, the recess (the outer circumference J section) is located on the opposite side of the pusher 65 with respect to the shaft hole 269a. Specifically, the transfer roller 19 does not apply pressure to the transfer belt 15 and the supporting roller 57.

[4b] When image formation is instructed, until the leading end of a first sheet moves to the transfer area where the transfer roller 19 and the transfer belt 15 are set in contact with each other (during toner image non-transfer), the cam 269 rotates according to the rotation of the stepping motor 75 such that the recess is located on the pusher 65 side with respect to the shaft hole 269a as substantially shown in FIG. 9. Specifically, pressure for setting the transfer roller 19 and the transfer belt 15 in contact with each other in the transfer area during toner image non-transfer is low compared with pressure during image transfer when the outer circumference K section is set in contact with the pusher 65.

[4c] The cam 269 rotates such that the outer circumference K section further moves the pusher 65 within a predetermined time in which the leading end of the sheet enters the transfer area. Consequently, transfer pressure necessary for transferring the toner image onto the sheet is applied to the toner image and the sheet.

[4d] Immediately before the trailing end of the sheet exits the transfer area, the cam 269 rotates to the outer circumference J section again. Consequently, near the trailing end of the sheet, pressure is low compared with the pressure in the transfer area during toner image transfer as in [4b].

[4e] The outer circumference I section moves the pusher 65 according to the continuing rotation of the cam 269. As explained above, the distance “i” between the outer circumference I section and the shaft hole 269a is longer than the distance “k” between the outer circumference K section for applying pressure to the transfer area to transfer the toner image and the shaft hole 269a. Therefore, while the next sheet moves to the transfer area and for a fixed time when no sheet is present near the transfer area, the pusher 65 further moves compared with the movement in applying pressure in the transfer area for bringing the transfer roller 19 and the transfer belt 15 and supporting roller 57 into contact with each other in the transfer area. Consequently, the pressure in the transfer area rises to be higher than the pressure during image transfer when the outer circumference K section is set in contact with the pusher 65. Transfer pressure higher than the pressure in [4c] necessary for transferring the toner image onto the sheet is applied to the transfer belt 15 and the supporting roller 57.

[4f] Thereafter, the cam 269 rotates from the outer circumference I section to the outer circumference J section within predetermined time in which the leading end of the sheet enters the transfer area. Specifically, pressure in the transfer area is low compared with the pressure in the transfer area during toner image transfer as in [4b].

[4g] Thereafter, the cam 269 rotates such that the outer circumference K section further moves the pusher 65 within the predetermined time in which the leading end of the sheet enters the transfer area ([4c]).

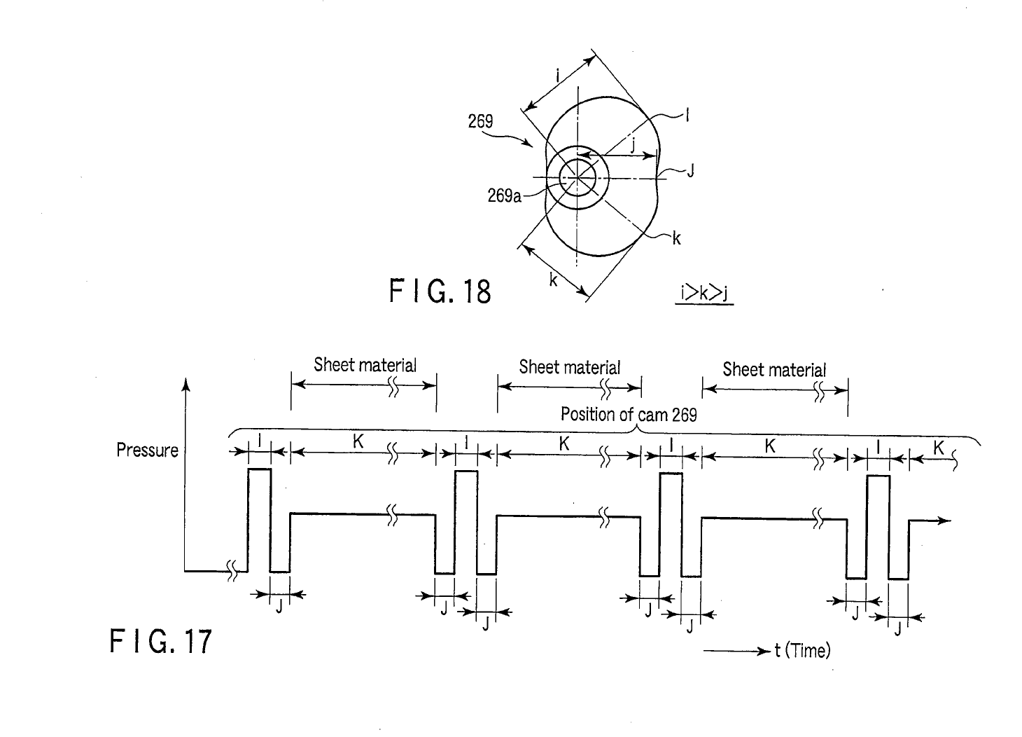

This makes it possible to further prevent, by applying pressure to the transfer belt, the transfer belt from being impacted when the sheet enters the transfer area or when the sheet exits the transfer area. Repetition of [4b] to [4g] is an example in which the transfer pressure applied to the transfer belt 15 and the supporting roller 57 by the transfer roller 19 is controlled according to the passage of the leading end and the trailing end of the sheet as shown in FIG. 17.

When the cam having the two recesses shown in FIG. 15 is used with a center thereof set in an outer circumference projection having a longest distance from the shaft hole of the cam shown in FIG. 18, it is possible to apply pressure to the transfer belt even when no sheet is present in the transfer area and it is possible to reduce time necessary for reversal (inversion) of the cam.

In each of a thick sheet and a thin sheet, speed fluctuation of the transfer belt occurs at a point when the sheet enters the transfer area and at a point when the sheet exits the transfer area.

In the thin sheet, since the sheet is thin and the rigidity of the sheet is low, speed fluctuation of the transfer belt due to entrance of the sheet in the transfer area and exit of the sheet from the transfer area less easily occurs. Therefore, pressure to be applied to the transfer area may not necessary to be reduced ahead.

On the other hand, concerning the thick sheet, since the rigidity of the sheet is high, speed fluctuation of the transfer belt due to entrance of the sheet in the transfer area and exit of the sheet from the transfer area tends to occur and adversely affects an image.

Therefore, concerning the thick sheet, it is desirable to provide, for example, a “thick paper mode” and, in the mode, set the pressure to the transfer belt low except during transfer of the toner image at timing when the sheet enters the transfer area or the sheet exits the transfer area.

In FIG. 12, solid line indicates pressure transition against the thick sheet and broken line indicates pressure transition against the thin sheet. The solid line partially overlaps with the solid line. To set the pressure low for the thick sheet, the motor driver 119 controls the stepping motor 75 to press the transfer roller 19 against the transfer belt 15 by a first pressure 201 before a leading edge of a thin sheet enters to a nip between the transfer roller 19 and the transfer belt 15 and controls the stepping motor 75 to press the transfer roller 19 against the transfer belt 15 at a second pressure 202 lower than the first pressure 201 before a leading edge of a thick sheet thicker than the thin sheet enters to the nip.

The motor driver 119 controls the stepping motor 75 to press the transfer roller 19 against the transfer belt 15 at a third pressure 203 higher than the first pressure 201 after the leading edge of the thin sheet enters to the nip.

The motor driver 119 controls the stepping motor 75 to press the transfer roller 19 against the transfer belt 15 at a fourth pressure 204 higher than the second pressure 202 after the leading edge of the thick sheet enters to the nip. The fourth pressure 204 may be different from the third pressure 203. The fourth pressure 204 may be set as same as the third pressure 203 to keep good transfer efficiency not only for the thin sheet but also for the thick sheet.

The motor driver 119 controls the stepping motor 75 to press the transfer roller 19 against the transfer belt 15 at a fifth pressure 205 higher than the second pressure 202 before a trailing edge of a preceding sheet nipped right before the thick sheet passes through the nip. The fifth pressure 205 may be different from the fourth pressure 204. The fifth pressure 205 may be set as same as the fourth pressure 204 to keep transfer efficiency.

The Thin sheet raises the pressure of the transfer roller 19 against the transfer belt 15 from the first pressure 201 to the third pressure 203 by entering the nip instead of rotation of the cam 69. In other word, the motor driver 119 needs not to control the stepping motor 75 to rotate the cam 69 from a position where the outer circumference A section or the outer circumference C section contact with the pusher 65 for the thin sheet.

The thickness of the sheet is detected by the media sensor 45. However, for example, when the “thick paper mode” is instructed from the control panel (the operating section) 9, the mode takes priority.

By applying the embodiments explained above, when the thick sheet is used, it is possible to suppress occurrence of an image failure that could occur because of a transfer failure.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A printer comprising:
an image holding member configured to hold an image;
a pressure applying member configured to nip a sheet with the image holding member by a first pressure, configured to nip the sheet with the image holding member by a second pressure lower than the first pressure; and
a driver configured to press the pressure applying member against the image holding member by the first pressure before a leading edge of a first sheet enters to the nip and configured to press the pressure applying member against the image holding member by the second pressure before a leading edge of a second sheet thicker than the first sheet enters to the nip.

2. The printer of claim 1, wherein the driver presses the pressure applying member against the image holding member by a third pressure higher than the first pressure after the leading edge of the first sheet enters to the nip.

3. The printer of claim 2, wherein the driver presses the pressure applying member against the image holding member by a fourth pressure higher than the second pressure after the leading edge of the second sheet enters to the nip.

4. The printer of claim 3, wherein the driver presses the pressure applying member against the image holding member by a fifth pressure higher than the second pressure before a trailing edge of a third sheet nipped right before the second sheet passes through the nip.

5. The printer of claim 1, further comprising:
a thickness checker configured to check thickness of a sheet to determine the first sheet and the second sheet.

6. The printer of claim 1, wherein the driver includes:
a turning member configured to turn the pressure applying member with a rotation center as a fulcrum;
a linear motion member configured to set a turning amount of the turning member according to linear motion; and
a driving mechanism configured to move the linear motion member.

7. The printer of claim 6, further comprising:
a sheet feeding mechanism configured to feed the sheet that holds the image to between the image holding member and the pressure applying member.

8. The printer of claim 6, further comprising:
a thickness checker configured to specify thickness of the sheet.

9. The printer of claim 6, wherein an amount of the movement by the driving mechanism is different when a pair or more of the sheets are continuously fed or only a singularity of the sheet is fed.

10. The printer of claim 6, wherein the driving mechanism has a circumferential surface that rotates around a shaft, the circumferential surface including at least a recessed area.

11. The printer of claim 10, wherein the driving mechanism rotates in a first direction and a second direction opposite to the first direction.

12. The printer of claim 11, wherein the circumferential surface includes a pair or more of the recessed areas.

13. The printer of claim 10, wherein an amount of the movement by the driving mechanism is different when a pair or more of the sheets are continuously fed or only a singularity of the sheet is fed.

14. The printer of claim 13, wherein the driving mechanism rotates in a first direction and a second direction opposite to the first direction.

15. The printer of claim 14, wherein the circumferential surface includes a pair or more of the recessed areas.

16. An image forming apparatus comprising:
a sheet feeder configured to feed a sheet;
an image holding member configured to hold an image;
a pressure applying member configured to nip the sheet fed by the sheet feeder with the image holding member by a first pressure, configured to nip the sheet with the image holding member by a second pressure lower than the first pressure; and
a driver configured to press the pressure applying member against the image holding member by the first pressure before a leading edge of a first sheet enters to the nip and configured to press the pressure applying member against the image holding member by the second pressure before a leading edge of a second sheet thicker than the first sheet enters to the nip.

17. The apparatus of claim 16, wherein the driver presses the pressure applying member against the image holding member by a third pressure higher than the first pressure after the leading edge of the first sheet enters to the nip.

18. The apparatus of claim 17, wherein the driver presses the pressure applying member against the image holding member by a fourth pressure higher than the second pressure after the leading edge of the second sheet enters to the nip.

19. The apparatus of claim 18, wherein the driver presses the pressure applying member against the image holding member by a fifth pressure higher than the second pressure before a trailing edge of a third sheet nipped right before the second sheet passes through the nip.

20. A method for forming an image comprising:
making an image on an image holing member;
pressing a nip between the image holding member and a pressure applying member; and
controlling the pressure applying to the nip with first pressure before a leading edge of a sheet enters to the nip and second pressure before a leading edge of a sheet thicker than the first sheet enters to the nip.
